(19) United States
(12) Patent Application Publication
(10) Pub. No.: US 2003/0211188 A1
(43) Pub. Date: Nov. 13, 2003

(54) Wireless image processing method and device therefor

(76) Inventor: Edward F. Kachnic, Douglasville, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/452,698

(22) Filed: Jun. 2, 2003

Related U.S. Application Data
(63) Continuation-in-part of application No. 09/644,389, filed on Aug. 23, 2000.
(63) Continuation-in-part of application No. 09/728,241, filed on Dec. 1, 2000, now Pat. No. 6,592,354.
(63) Continuation-in-part of application No. 09/738,602, filed on Dec. 16, 2000, now Pat. No. 6,592,355.
(60) Provisional application No. 60/212,518, filed on Jun. 19, 2000.

(51) Int. Cl. B29C 37/00

(52) U.S. Cl. 425/137; 425/169

(57) ABSTRACT

A wireless image processing method and device for utilization in combination with a machine vision system, preferably a part-forming machine, wherein a wireless communicator delivers images to a host computer that can analyze the data and determine functionality to the manufacturing process, wherein the host computer can incorporate wireless components, wherein wireless signals can be sent and/or received to input/output modules to control the processes, and wherein the input/output modules can affect said control wirelessly, thereby minimizing and/or eliminating physical cabling and wiring constraints to enable smaller implementations, increased analysis capabilities, and improved price/performance ratios. Alternatively, an image analyzing means may be integrated with an image capturing means, wherein a control signal can be wirelessly communicated to affect the manufacturing process.

### PRIORITY CLAIM AND CROSS REFERENCES

The present application is a continuation-in-part and claims the benefit of pending nonprovisional patent application Ser. No. 09/644,389, filed Aug. 23, 2000, entitled PART-FORMING MACHINE CONTROLLER HAVING INTEGRATED SENSORY AND ELECTRONICS AND METHOD THEREOF, which is a nonprovisional patent application of provisional patent application, serial No. 60/212,518, filed on Jun. 19, 2000, entitled PART-FORMING MACHINE CONTROLLER HAVING INTEGRATED SENSORY AND ELECTRONICS AND METHOD THEREOF; and pending nonprovisional patent application, Ser. No. 09/728,241, filed Dec. 1, 2000, entitled PART FORMING MACHINE HAVING AN INFRARED VISION SYSTEM AND METHOD FOR VERIFYING THE PRESENCE, ABSENCE AND QUALITY OF MOLDED PARTS THEREIN; and pending nonprovisional patent application Ser. No. 09/738,602, filed Dec. 16, 2000, entitled PART-FORMING MACHINE HAVING AN IN-MOLD INTEGRATED VISION SYSTEM AND METHOD THEREFOR.

### TECHNICAL FIELD

The present invention relates generally to machine vision systems, and more specifically, to a wireless image processing method and device for utilization in combination with a machine vision system, preferably a part-forming machine.

### BACKGROUND OF THE INVENTION

Machine vision systems are relied upon throughout a vast array of industries for computerized inspection of parts and assistance in/direction of operational control of automated and semi-automated systems for the production and/or manipulation thereof. Products particularly suitable for utilization of such image analysis methods include, for instance, formed or molded plastic parts, semiconductors and machined parts. Other uses of machine vision systems include inspection of remote, otherwise inaccessible cavities, such as within a fuel cell or jet engine, wherein identification of stress failures and/or otherwise weakened components is critical.

In each instance, a variety of image data is acquired from a target site and is analyzed by a computer according to a comparative or otherwise objective specification. The analysis results are reported to a controller, whereby decisions are influenced and/or actions are directed as a result thereof.

The parts-forming industry is but one of the regular users of such machine vision based systems, albeit one of the world's largest industries in both total revenue and employment. As a multi-billion dollar industry, even small improvements to equipment design can provide an enormous increase in the efficiency of the manufacturing process and thereby generate a tremendously beneficial financial impact. This holds true for other machine vision system users as well, especially volume-oriented automated producers.

Formed parts are generally created via molds, dies and/or by thermal shaping, wherein the use of molds remains the most widely utilized. There are many methods of forming a part via a mold, such as, for exemplary purposes only, stretch-blow molding, extrusion blow molding, vacuum molding, rotary molding and injection molding. Injection molding is one of the most popular methods and is a method wherein the utilization of machine vision methodology can increase efficiency via improved quality of task performance and increased part production.

Because a typical injection molding system is used for molding plastic and some metal parts by forcing liquid or molten plastic materials or powdered metal in a plastic binder matrix into specially shaped cavities in molds where the plastic or plastic binder matrix is cooled and cured to make a solid part, the monitoring and reporting on system operational parameters and/or part formation is critical to high-throughput requirements. One such operational parameter is the automated control of ejector apparatus that typically dislodges or pushes hardened plastic parts from a mold cavity, wherein a typical ejector apparatus includes one or more elongated ejector rods extending through a mold half into the cavity or cavities and an actuator connected to the rod or rods for sliding or stroking them longitudinally into the cavity or cavities to push the hard plastic part or parts out of the cavity or cavities. Other types of ejector apparatus are also utilized, such as robotic arms, scrapers or other devices. However, it is recognized that machine vision systems may be utilized to influence the operation of any type of ejector apparatus, any other type of operational parameter for an automated or semi-automated part-forming machine, or any other type of automated or semi-automated production or inspection system.

With respect to the utilization of machine vision systems for operational control of ejector apparatus of a part-forming machine, because it is not unusual for a hard plastic part to stick or hang-up in a mold cavity in spite of an actuated ejector, prior to the introduction of such machine vision systems, one common technique was to design and set the ejectors to actuate or stroke multiple times in rapid succession, such as four or five cycles each time a hard plastic part is to be removed, so that if a part sticks or is not removed from a mold cavity the first time it is pushed by an ejector, perhaps it can be dislodged by one or more subsequent hits or pushes from the ejectors. Through the use of machine vision systems, however, additional time previously required for pre-set multiple ejector cycling could be substantially eliminated and wear and tear on the ejector equipment and molds could be reduced. Moreover, damage to molds and lost production time from stuck or otherwise incompletely ejected hard parts can be avoided by visual inspection. Thus, such improvements, over the course of days, weeks, and months of injection molding parts in repetitive, high volume production line operations, can significantly bear on production quantity and cost factors.

One example, U.S. Pat. No. 5,928,578, issued to Kachnic et al., provides a skip-eject system for an injection molding machine, wherein the system comprises a vision system for acquiring an actual image of an open mold after a part ejector has operated and a controller for comparing such actual image with an ideal image of the open mold to determine if the part still remains in the mold. As such, signals to and from the machine controller in response to the image analysis are critical to ensure proper and timely automatic cycling.

While each sensory improvement can and does increase quality and productivity for part-forming processes, as well as other machine vision applications, resultant increases in cabling and wiring between components introduce practical limitations. Typical system-level solutions for machine vision applications include a CCD (charge-coupled device) or CMOS (complementary metal-oxide semiconductor) camera having sensors combined with RAM (random access memory), a microprocessor and cabling combined with firmware and/or software analysis features. Thus, while more electronic capability can be placed at the viewing position, physical limitations result from incorporating all necessary hardware and image processing firmware into the same package.

Therefore, it is readily apparent that there is a need for a wireless image processing method and device, wherein physical limitations can be minimized or overcome and a remote host computer can be utilized to process image data, thereby enabling the utilization of a competitively priced and easily replaceable high performance, off-the-shelf host computer, enabling host miniaturization of the image sensor for smaller implementations, and enabling concurrent analysis of a plurality of sensors by one remote host, thus eliminating costly customized direct wiring expenses and avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a wireless image processing method and device for utilization in combination with a machine vision system, preferably a part-forming machine, wherein a wireless communicator delivers image data to a host computer that can analyze the data and determine functionality to the manufacturing process, wherein the host computer can incorporate wireless components, wherein wireless signals can be sent and/or received to input/output modules to control the processes, and wherein the input/output modules can affect said control wirelessly, thereby minimizing and/or eliminating physical cabling and wiring constraints to enable smaller implementations, increased analysis capabilities, and improved price/performance ratios.

According to its major aspects and broadly stated, the present invention is a wireless image processing method and device, wherein physical limitations can be minimized or overcome and a remote host computer can be utilized to process image data, thereby enabling the utilization of a competitively priced and easily replaceable high performance, off-the-shelf host computer with wireless components, enabling host miniaturization of the image sensor for smaller implementations, and enabling concurrent analysis of a plurality of sensors by one remote host, thus eliminating costly customized direct wiring expenses.

More specifically, the device of the present invention in its preferred form replaces the physical cabling, wiring and/or bus interfaces necessary for information exchange and communication between sensory devices for a part-forming machine and the controller of the sensory devices and part-forming machine (typically a personal computer) with a wireless signal transmission system, thereby enabling the controller to be positioned at a physically remote location from the part-forming machine while still contemporaneously receiving input signal(s)/data from the sensory device, analyzing the data, providing an output signal to the sensory device and communicating directly with the machine controller software. The integration of a wireless signal transmission system, according to the present invention, into a part-forming machine environment enables a single controller, or personal computer, to be utilized to analyze the status of a plurality of molds and/or formed parts and to act as a remote host control for the operation of a plurality of part-forming machines.

Additionally, according to the present invention, image data could be wirelessly communicated to a plurality of host computers, wherein specific or targeted data is being acquired and/or analyzed and/or particular tasks are being directed independently thereby. Any combination of wireless system components, including but not limited to the sensory devices, the input/output controller of the sensory devices, the host computer(s) components, and modular components of an automated or semi-automated system could be utilized, wherein overall system modularity would be maximized and/or individual system needs could be addressed via utilization of a wireless image data acquisition and transfer system, utilization of a wireless input/output data transmission system and/or a combination system supporting the wireless transfer of both image and input/output data.

Thus, a feature and advantage of the present invention is the ability of such a wireless image processing method and device to enable modular conformation of machine vision system components.

Another feature and advantage of the present invention is the ability of such a wireless image processing method and device to be utilized in combination with a part-forming machine to enable remote analysis of the presence, absence and/or quality of the molded part.

Another feature and advantage of the present invention is the ability of such a wireless image processing method to facilitate flexibility of machine vision systems, thereby enabling inspection of remote, otherwise inaccessible targets.

Another feature and advantage of the present invention is the ability of such a wireless image processing method and device to minimize and/or overcome physical limitations of machine vision systems.

Another feature and advantage of the present invention is the ability of such a wireless image processing method and device to enable the utilization of a remote host computer to process image data from a part-forming machine or machines or other machine vision system.

Another feature and advantage of the present invention is the ability of such a wireless image processing method and device to enable the utilization of a remote host computer to wirelessly control operational parameters of a part-forming machine or machines or other machine vision system.

Another feature and advantage of the present invention is the ability of such a wireless image processing method and device to enable the reception and transmission of radiofrequency (RF) waves by input/output modules and/or by the computerized controller of a part-forming machine or machines or other machine vision system, that is, to enable the wireless transfer of either image data, input/output control data, or both.

Another feature and advantage of the present invention is the ability of such a wireless image processing method and device to enable the utilization of a competitively priced and easily replaceable high performance, off-the-shelf host computer to analyze data from a part-forming machine.

Another feature and advantage of the present invention is the ability of such a wireless image processing method and device to support the utilization of wireless signal transfer between machine components, between controller components, and/or between sensory components, and/or to support the utilization of wireless signals for inter-component communications, such as between the machine components and the controller components, between the machine components and the sensory components, and/or between the sensory components and the controller components.

Another feature and advantage of the present invention is the ability of such a wireless image processing method and device to facility quick and efficient component exchange and/or replacement without necessitating wiring, rewiring or other installation complications.

Another feature and advantage of the present invention is the ability of such a wireless image processing method and device to enable host miniaturization of the image sensor for smaller implementations.

Another feature and advantage of the present invention is the ability of such a wireless image processing method and device to enable concurrent analysis of a plurality of sensors from a part-forming machine or machines or other machine vision system by one remote host.

Another feature and advantage of the present invention is the ability of such a wireless image processing method and device to eliminate costly customized direct wiring expenses.

Another feature and advantage of the present invention is the ability of such a wireless image processing method and device to facilitate the synergistic combination of a multitude of sensory devices.

Another feature and advantage of the present invention is the ability of such a wireless image processing method and device to enable a physically remote personal computer to act as a quality control inspection station for one or more molds and/or part-forming machines, enabling measurement detection and sorting of formed parts for quality defects. That is, parts can be inspected on the parting line surface in the mold or removed from the mold via a robotics type device and presented to one or more sensors. Quality data can be processed before or in parallel with the next molding cycle to determine pass or fail of the inspection criteria. Feedback to the molding process can be given to continue, adjust the process, or stop the molding process and wait for manual intervention. Part quality is verified and the overall part forming process is improved by reducing the number of defective parts produced.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a functional diagram of a wireless image processing method according to a preferred embodiment of the present invention.

FIG. 2 is a partial cross-sectional side elevation view of a typical injection molding machine showing a machine vision sensor and showing the ejectors retracted;

FIG. 3 is a partial cross-sectional side elevation view of the injection molding machine of FIG. 2 showing the ejectors extended;

FIG. 4 is a diagrammatic representation of a wireless image processing system and device according to a preferred embodiment of the invention;

FIG. 5 is a diagrammatic representation of a wireless image processing system and device according to an alternate embodiment of the invention;

FIG. 6 is a functional diagram of a wireless image processing method according to an alternate embodiment of the present invention.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

With regard to all such embodiments as may be herein described and contemplated, it will be appreciated that optional features, including, but not limited to, aesthetically pleasing coloration and surface design, and labeling and brand marking, may be provided in association with the present invention, all without departing from the scope of the invention.

To better understand the present system and method of this invention, it will be specifically explained in the context of a particular machine vision system, that is, its preferred use in conjunction with an injection molding system. However, it is expressly understand and contemplated that the wireless image processing method described herein is suitable for utilization in combination with any machine vision system such as, for exemplary purposes only, for the inspection of machined parts, for inspection of remote, otherwise inaccessible targets and for monitoring of automated production performance and quality.

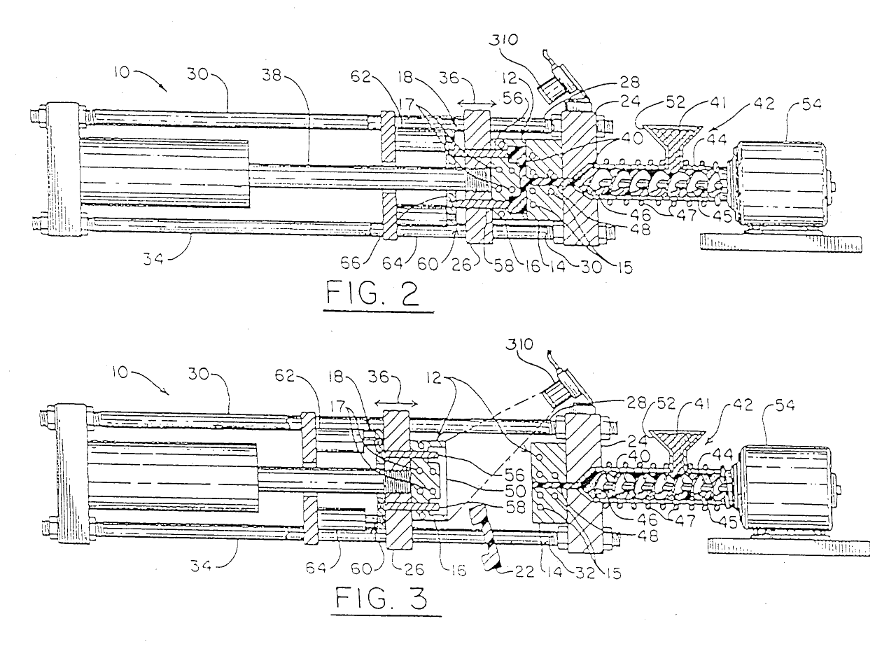

With reference to the preferred, exemplary use in combination with an injection molding machine and the process thereof, referring first to FIGS. 2-3, a conventional automated injection molding machine 10 is shown equipped with a mold 12 comprising two mold halves 14, 16, a sliding rod-type ejector system 18, and sensor 20 for acquiring visual images of the open mold half 14 in electronic format that can be digitized, stored in memory, and processed to detect presence or absence of a plastic part or material in the mold half 14. Preferably, sensor 20 is an infrared (IR) camera 310 for acquiring visual near-infrared images; however, any suitable sensor or camera may be utilized, such as, for exemplary purposes only, a CMOS (complementary metal oxide semiconductor) or CCD (charge-coupled device) array electronic camera 20 for acquiring visual images in electronic pixel format, a video data collection terminal, an ultrasonic sensor or any suitable optical imaging device capable of generating computer readable image data of a visual representation.

In general, the exemplary conventional injection molding machine 10 comprises two platens 24, 26 mounted on a frame made of four elongated, quite substantial frame rods 28, 30, 32, 34 for mounting the two halves 14, 16 of mold 12. Stationary platen 24 is immovably attached to rods 28, 30, 32, 34, while moveable platen 26 is slidably mounted on rods 28, 30, 32, 34 so that it can be moved back and forth, as indicated by arrow 36, in relation to stationary platen 24. Therefore, mold half 16 mounted on moveable platen 26 is also moveable as indicated by arrow 36 in relation to the other mold half 14 that is mounted on stationary platen 24. A large hydraulic or mechanical ram 38, which is capable of exerting a substantial axial force, is connected to moveable platen 26 for moving mold half 16 into contact with mold half 14 and holding them together very tightly while liquid or molten plastic 40 is injected into mold 12, as best seen in FIG. 2.

Most molds 12 also include internal ducts 15, 17 for circulating heating and cooling fluid, such as hot and cold water, through the respective mold halves 14, 16. Cooling fluid supply hoses 19, 21 connect respective ducts 15., 17 to fluid source and pumping systems (not shown). Hot fluid is usually circulated through ducts 15, 17 to keep mold 12 hot during the injection of liquid or molten plastic 40 into cavity 50. Then, cold fluid is circulated through ducts 15, 17 to cool mold 12 to allow the liquid or molten plastic 40 to solidify into hard plastic part 22.

A typical plastic injector or extrusion system 42 may comprise an injector tube 44 with an auger 45 in tube 44 for forcing the liquid or molten plastic 40 through aperture 46 in stationary platen 24 and through duct 48 in mold half 14 into mold cavity 50 that is machined or otherwise formed in mold half 16. In many applications, there are more cavities than one in mold 12 for molding cycle. In such multiple cavity molds, multiple ejectors may be required to eject the hard molded parts from all of the cavities. Plastic extrusion system 42 also includes a hopper or funnel 52 for filling tube 44 with the granular solid plastic 41, a heating coil 47 or other heating system disposed around tube 44 for heating granular plastic 41 enough to melt it in tube 44 to liquid or molten plastic 40, and motor 54 for driving auger 46.

After the liquid or molten plastic 40 is injected into mold 12 to fill mold cavity 50, as illustrated in FIG. 2, and after the plastic 40 in mold cavity 50 has solidified as described above, ram 38 is actuated to pull mold half 16 away from the mold half 14 so that hard plastic part 22 can be ejected from mold cavity 50. Once mold halves 14, 16 are separated, part-forming machine controller 72 sends a signal to sensor 20 to acquire a first image of mold half 16, wherein the image is analyzed to ensure the presence of part 22 in mold half 16.

Ejection of hard plastic part 22, as mentioned above, can be accomplished by a variety of mechanisms or processes, and the ejector system 18 illustrated in FIGS. 2-3 is but one example. Ejector system 18 includes two slidable ejector rods 56, 58 that extend through moveable platen 26 and through mold half 16 into mold cavity 50. When mold 12 is closed for filling mold cavity 50 with plastic 40, as shown in FIG. 2, ejector rods 56, 58 extend to, but not into, mold cavity 50. However, when mold 12 is opened, as shown in FIG. 3, ejector actuator 60, which comprises two small hydraulic cylinders 62, 66 and cross bar 68 connected to ejector rods 56, 58, pushes ejector rods 56, 58 into mold cavity 50 to hit and dislodge hard plastic part 22 and push it out of cavity 50. Because one hit or push by ejector rods 56, 58 is occasionally not enough to dislodge and push hard plastic part 22 all the way out of cavity 50, it is a common practice to cycle ejector actuator 60 several times to cause ejector rods 56, 58 to reciprocate into and out of cavity 50 repetitively so that, if hard plastic part 22 is still in cavity 50, it will get hit and pushed several times, thus reducing instances when hard plastic part 22 does not get completely ejected to a minimum.

Next part-forming machine controller 72 sends a signal to sensor 20 to acquire an image of mold half 16, including cavity 50, and then the image is sent in electronic form to an image processing system, where it is digitized and compared by a computer or microprocessor to an ideal image of mold half 16 and empty mold cavity 50. If the image comparison shows that mold cavity 50 is empty and that hard plastic part 22 has been cleared from the mold half 16, ram 38 is actuated to close mold 12 to start a new molding cycle. On the other hand, if the image comparison shows that hard plastic part 22 has not been dislodged from cavity 50 or cleared from mold half 16, then ram 38 is not allowed to close mold 12, and a signal is generated to notify an operator to check mold 12, clear any residual plastic or hard plastic part 22 from cavity 50 and mold 12, and then restart plastic injection molding machine 10.

As discussed above, the repetitive cycling of the ejector rods 56, 58 that is practiced in some conventional injection molding systems reduces occurrences of hard plastic part 22 not being dislodged from cavity 50 and removed from mold half 16. However, for the many instances when one hit or push by ejector rods 56, 58 would be sufficient to dislodge and remove hard plastic part 22, which far outnumber the instances when additional hits or pushes by the ejector rods 56, 58 are necessary, the repetitive cycling of the ejector system 18 every time the mold 12 is opened also takes unnecessary time and causes unnecessary wear and tear on the ejector system 18 and mold 12. As an improvement, a skip-eject system, as found in U.S. Pat. No. 5,928,578 to Kachnic et al., is typically utilized, wherein the ejector system 18 is actuated only when necessary. For instance, instead of using a large, fixed number of ejector rod 56, 58 strokes or cycles for every time mold 12 is opened in plastic part molding cycles, a variable number of ejector rod 56, 58 strokes is used to match each molding cycle's ejection needs. The repetition of stroke cycles is dependent on the image of mold 12 as obtained via sensor 20.

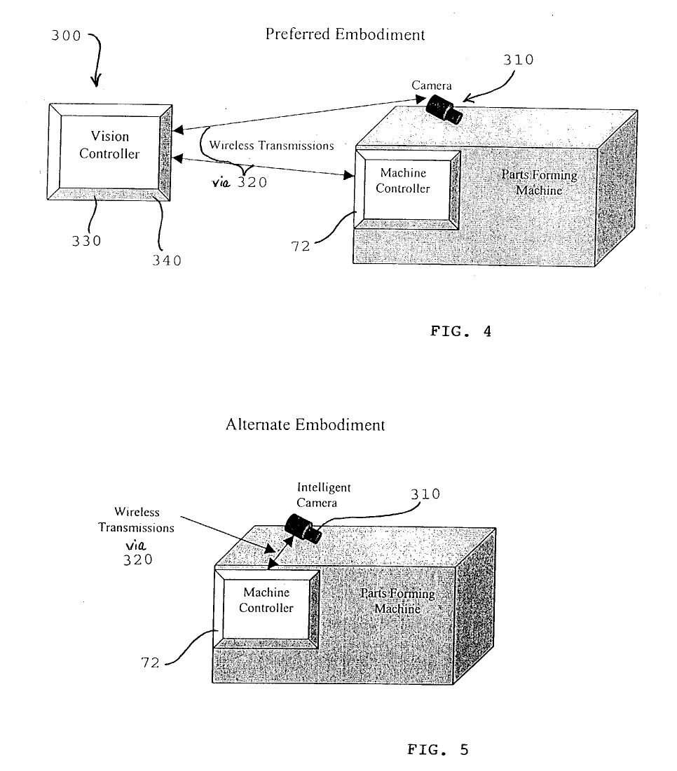

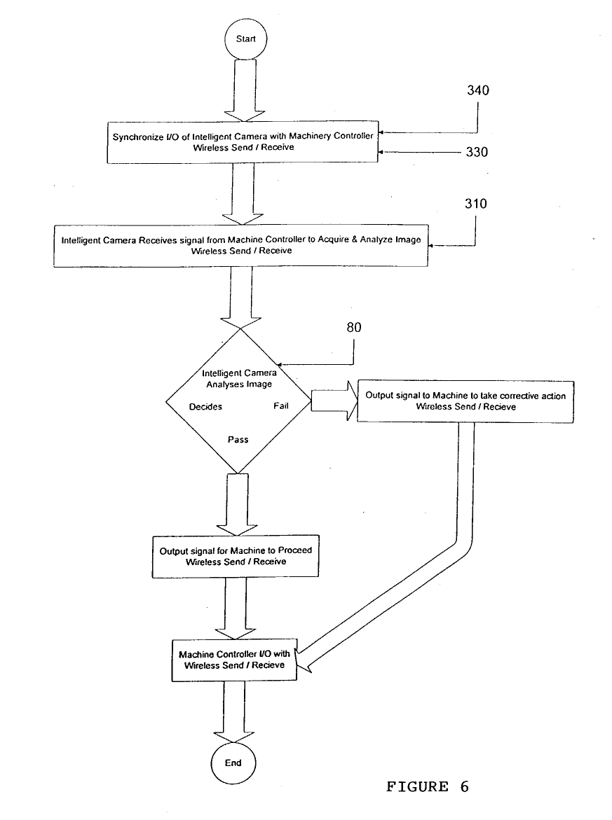

In one embodiment of the present invention, as depicted in FIG. 4, sensoring system 300 comprises image capture source 310, wireless image transfer system 320, sensor device 330 and analyzing means 340, wherein the analyzing means 340 is preferably a remotely positioned, wirelessly linked computer or microprocessor. Image capture source 310 is positioned preferably within mold half 14, illustrated in FIGS. 2-3, facing toward the surface of mold half 16 such that the facing surfaces of mold half 16 and mold half 14 are positioned generally parallel to each other, wherein mold half 16 and mold half 14 separate along a relatively parallel direction of travel and wherein image capture source 310 is preferably in view of mold half 16 along the direction of travel and the parts formed by the machine 10 are preferably imageable by image capture source 310 during mold travel. However, it should be noted that in alternate embodiments, such as is illustrated in FIG. 5, image capture source 310 may be positioned at various locations within the mold such that various parts or specific areas of parts may be imaged at any angle. It is also contemplated that any number of image capture sources 310 may be positioned at various positions within the mold to increase resolution and/or to improve the image analysis process.

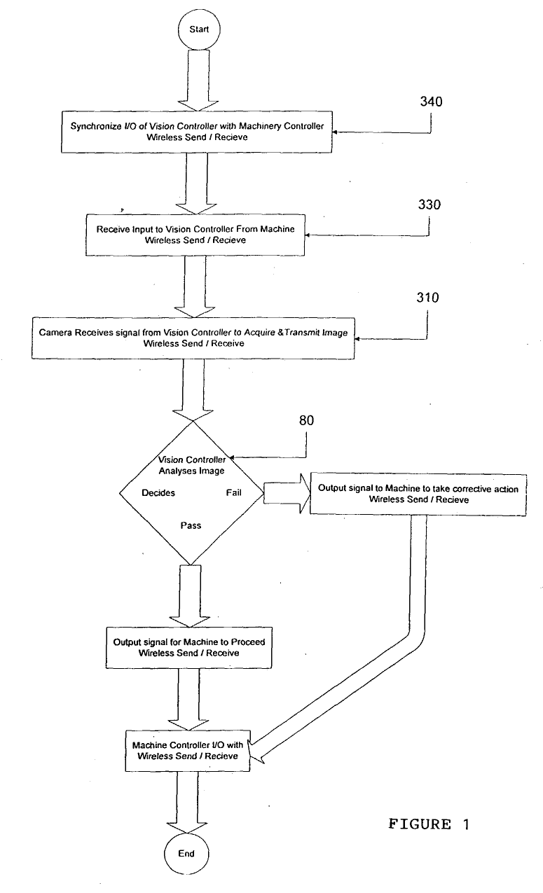

The preferred wireless image functional process of the present invention is diagrammatically represented in FIG. 1. Image capture source 310 preferably enables capture of light waves and/or radiation, preferably at near-infrared wavelengths. It is contemplated that image capture source 310 could be a digital camera, video camera, image scanner or any other suitable type of data collection terminal and/or optical imager. The image captured thereby is preferably allowed to travel wirelessly to sensor device 330 via wireless image transfer system 320. Wireless image transfer system 320 incorporates appropriate wireless transmission capabilities, such as, for exemplary purposes only, spread-spectrum radio frequency or infrared signal communication platforms, wherein image capture source 310 preferably generates computer readable image data of the optically imaged visual representation and wherein such creation of the electronic image facilitates digitization and transmission thereof for reading and/or analysis at a remote location. The image may be in any suitable format such as, for exemplary purposes only, mega pixel format, video graphic array (VGA), common intermediate format (CIF), quarter common intermediate format (QCIF), or any other format suitable for such an image capture and transmission application.

Wireless image transfer system 320 allows the image of mold half 16 and/or part 22 to be viewed remotely by sensor device 330, thus preventing the sensor device from being exposed to the high temperatures of mold 12. Preferably sensor device 330 is positioned remotely to the mold half 14; however, in alternate embodiments, the sensor device 330 may be positioned external to the mold half 14 or within one of mold halves 14, 16 at a lower temperature point from the part-forming area such that the sensor device 330 is not damaged by the high temperatures. It is also contemplated that the sensor device 330 may be thermally insulated and/or have various known heat removal systems to protect sensor device 330 and thus allow it to be positioned within the mold.

Image capture source 310 is preferably a complementary metal-oxide semiconductor (CMOS) image sensor, thereby enabling sensor device 330 to randomly access specific pixels on the sensor array. However, in alternate embodiments, image capture device 310 may be any imaging device such as, for exemplary purposes only, a charge coupled device (CCD) array electronic camera, an infrared or near infrared camera or infrared heat sensor.

In the preferred embodiment, analyzing means 340 receives an electronic representation of the acquired image from sensor device 330, analyzes said image and wirelessly communicates the presence or absence of molded parts within mold 12 to part-forming machine controller 72. Given known parameters, one skilled in the art would be able to develop software for analyzing the images of the mold 12. Analyzing means 340 is preferably a physically remote host computer that is wirelessly and communicationally linked with part-forming machine controller 72. It is anticipated that analyzing means 340 could be a wireless, modular host computer system, wherein essentially unlimited portability would facilitate cooperative and shared utilization between a plurality of machine vision systems. It is also anticipated that analyzing means 340 could be integrated with, or a sub-component of, image capture device 310, wherein image capture device 310 could be an “intelligent” sensor with on-board image analysis capabilities and the ability to communicate analytical results to part-forming machine controller 72, wherein the functional process of the alternate “intelligent” sensor is diagrammatically illustrated in FIG. 6.

It is preferred that part-forming machine controller 72 is wirelessly enabled for the transmission/reception of input/output data. Like the image data, the I/O data may be communicated via any type of wireless transmission, such as, for exemplary purposes only, spread-spectrum radio frequency or infrared signal communication platforms. It is also anticipated that, in order to accommodate individual application preferences, the present invention could be utilized with only image data transfer occurring via a wireless format, or, alternatively, with only I/O data transfer occurring via a wireless format, wherein the other data component could incorporate a traditional hard-wire transfer system.

The preferred positioning of capture source 310 enables image acquisition to begin as soon as sensor device 330 receives a wireless signal transmission from machine controller 72 that the mold is beginning to open, wherein preferably the first image is immediately acquired while mold 12 is opening, in lieu of waiting for a signal from machine controller 72 that mold 12 has completely opened. The wirelessly transmitted image data is then analyzed by remote host computer 340 to ensure that part 22 is present on the moving side of mold 12, mold half 16; analyzing means 340 sends a wireless transmission signal to machine controller 72 to this affect. Next, a first cycle of ejector rods 56, 58 is performed. A second image is acquired and analyzed to determine the absence of part 22 in mold half 16, wherein if analysis indicates that part 22 is still present, another series of cycle of ejector rods 56, 58 is performed or an alarm is activated, depending on the number of cycles performed, to indicate to the operator that part 22 is stuck. If the second image indicates that part 22 is absent, analyzing means 340 sends a wireless transmission signal to machine controller 72 to close mold 12 and begin the next molding process.

More specifically, in the first state A, analyzing means 340 sends a wireless transmission to signal mold 12 to close. In response, a close/open mechanism that includes a ram actuator preferably wirelessly actuates ram 38 to close and press mold half 16 against mold half 14 and is followed by actuation of plastic extrude system 42 to inject liquid or molten plastic into mold 12 to form a plastic part. After allowing sufficient time for the plastic to harden, the process advances to state B in which ram 38 is actuated to pull mold half 16 away from mold half 14. While mold 12 is opening, an image of the open mold half 16 is acquired by sensor device 330 via capture source 310 and transmitted via spread-spectrum radio frequency, infrared signal communication platforms, or any other suitable wireless transmission system to analyzing means 340, preferably a host computer positioned at a physically remote location, wherein analyzing means 340 compares the image to an ideal image of mold half 16 as it should appear with a properly formed plastic part 22 in cavity 50. At this point in the sequence, there should be a fully-formed hard plastic part 22 in mold half 16. Therefore, if the comparison indicates that no plastic part 22 is present in mold half 16 or that plastic part 22 is present but incompletely formed, analyzing means 340 stops the sequence and generates a signal to an alarm 82 or other device, to signal an operator 86 to come and check injection molding machine 10. However, if the comparison indicates that a fully-formed plastic part 22 is present in mold half 16, as it is supposed to be, analyzing means 340 causes the sequence to continue to state C by sending a wireless transmission signal to actuate ejector system 18 to extend ejector rods 56, 58 to cycle once to hit or push the hard plastic part out of mold half 16. However, as discussed above, occasionally, one extension of ejector rods 56, 58 will not dislodge or clear the hard plastic part 22 from mold half 16. Therefore, the preferably remotely located host computer analyzing means 340 causes the sequence to proceed to state D.

In state D, analyzing means 340 receives another wireless transmission of an image of mold half 16 acquired by sensor device 330 via capture source 310 and compares it to an ideal image, which is stored in memory, of mold half 16 with hard plastic part 22 removed and mold cavity 50 empty. If the comparison indicates that part 22 is cleared and cavity 50 is empty, analyzing means 340 continues the sequence back to state A by sending a wireless transmission signal via infrared, radiowaves, or any other suitable wireless transmission carrier to actuate ram 38 to again wirelessly affect the closure of mold 12 and to wirelessly actuate extruder system 42 to again fill mold 12 with plastic. On the other hand, if the comparison indicates part 22 is stuck in mold half 16 or otherwise not cleared, then preferably remotely positioned host computer, analyzing means 340, proceeds to check the number of times that the ejector rods 56, 58 have been extended or cycled. If ejector rods 56, 58 have been cycled more than some reasonable number, such as five (5), in unsuccessful tries to dislodge and clear part 22 from mold half 16, analyzing means 330 stops the sequence, and proceeds to signal alarm 82 or other device 86 to call the operator. However, if the number of tries has not exceeded the number, such as five (5), analyzing means 340 returns the sequence to state C by wirelessly transmitting a signal to the ejector actuator to again fire or cycle ejector rods 56, 58 to hit or push part 22 once again. Analyzing means 340 then continues the sequence again to state D where another image of mold half 16 is acquired with sensor device 330 and compared again to the ideal image of how mold half 16 should appear with the part cleared. If part 22 was successfully cleared by the last extension or cycle of ejector pins 56, 58, the sequence proceeds to state A. However, if the comparison at 92 indicates part 22 is still stuck or not cleared, analyzing means 340 checks the number of tries at 98 and, if not more than the number, e.g., five (5), returns the sequence to state C again. The maximum number of tries can be any number, but it is preferably set at a number, for example five (5,), that is deemed to allow enough cycles or extensions of ejector rods 56, 58 to reasonably be expected to dislodge and clear part 22 without becoming practically futile. Thus, multiple cycles of extensions and retractions of ejector rods 56, 58 are available and used only when part 22 gets stuck, and unneeded repetitive cycles of the ejector rods 56, 58 are prevented when the part 22 has been dislodged and cleared from the mold.

Preferably, the sensor or camera of sensor device 330 is held at a minimized and/or relatively parallel angle with the target, wherein the view area for each pixel is generally free from distortion, thereby resulting in an image having higher resolution. As a result, more accurate analysis can be made with images having better resolution. Also preferably, the sensor or camera of sensor device 330 receives commands and transmits image data via a wireless communication link.

In the preferred embodiment, sensor device 330 has an illumination source that can directly illuminate part 22 and/or mold 12 at a substantially parallel angle thereto. As a result, better lighting of the target area is possible thus increasing the clarity and accuracy of the acquired image.

It should be noted that although the above wireless image transmission method and device is described in combination for use with a skip-eject system, the wireless image transmission method and device may be utilized with any part-forming machine or any other type of automated or semi-automated production, inspection and/or assembly system wherein machine vision analysis may be incorporated. It should also be noted that any number of sensor devices 330 and/or capture sources 310 may be utilized, wherein more than one sensor device 330 and/or capture source 310 may transmit image data via wireless transmission to remote host computer for subsequent analysis.

It should also be noted that an infrared (IR) emitting source, known within the art, may be utilized, wherein the source emits IR or near IR frequencies to assist in imaging the mold/part. An IR filter may also be utilized, wherein non-IR frequencies are blocked from entering the IR sensors, thus allowing IR frequencies to pass.

It should be further noted that wireless image transfer system 320 could also include a buffer, wherein the buffer could be integrated on a single chip to temporarily store image data for subsequent and/or generally contemporaneous transmission.

It should also be noted that while it is preferred that the combination of wireless system components is maximized, that is, that the sensory devices, the controller of the sensory devices, the host computer(s) components, and available modular components of an automated or semi-automated system are capable of sending and receiving wireless transmissions, any combination thereof could be utilized, wherein one or more components could be wireless and another component or components could be wired.

It should also be noted that while it is preferred that both a wireless image data acquisition and transfer system and a wireless input/output data transmission and control system are utilized to maximize the efficiency, modularity, and overall benefits of the present invention, either wireless component could be utilized individually, wherein the other component could be traditionally hard-wired.

It should further be noted that, in an alternate embodiment, image capture device 310 could have built-in analysis capabilities, wherein image analysis could be self-conducted and communicated to the machine controller thereby, and wherein one skilled in the art could provide software to direct machine performance in response to communications from a plurality of such intelligent sensors in machine systems utilizing multiple imaging devices or cameras.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An image processing device for use with a machine for forming parts, comprising:
at least one sensor, wherein the parts formed by the machine are imageable by said at least one sensor;
means for wirelessly transmitting the image captured by said at least one sensor;
means for analyzing the image, received from said transmitting means, wherein said means for analyzing indicates the presence, absence or quality of at least one of the parts; and
means for wirelessly transmitting said indication to the machine, wherein the operation thereof is responsive to said indication.

2. The wireless image processing device of claim 1, wherein said means for analyzing the image is a program.

3. The wireless image processing device of claim 1, wherein said means for analyzing the image is a programmable microprocessor.

4. The wireless image processing device of claim 1, wherein said at least one sensor is at least one charge coupled device camera.

5. The wireless image processing device of claim 1, wherein said at least one sensor is at least one near-infrared camera.

6. The wireless image processing device of claim 1, wherein said at least one sensor is an optical imaging device capable of generating computer readable image data of a visual representation.

7. The wireless image processing device of claim 1, wherein said means for wirelessly transmitting the image and said means for wirelessly transmitting said indication is a spread spectrum radio frequency signal.

8. The wireless image processing device of claim 1, wherein said means for wirelessly transmitting the image and said means for wirelessly transmitting said indication is an infrared signal communication platform.

9. A part-forming machine, comprising:
a mold;
means for ejecting at least one of the parts from said mold; and
means for controlling said ejecting means, wherein said means for controlling said ejecting means is a wireless image processing system having at least one sensor and at least one central processing unit.

10. The machine of claim 9, wherein said ejecting means is at least one ram.

11. The machine of claim 9, wherein said sensor is at least one complementary metal-oxide semiconductor (CMOS) imaging device.

12. The machine of claim 9, wherein said sensor is at least one infrared sensor.

13. The machine of claim 9, wherein said at least one sensor and said at least one central processing unit of said wireless image processing system are integrated into at least one analytically-adept sensor/processor device.

14. A machine for forming parts, comprising:
a mold having an interior and an exterior;
means for ejecting at least one of the parts from said mold;
means for controlling said ejecting means;
means for capturing an image;
a sensor device in wireless communication with said image capture means; and
means for analyzing the image captured by said sensor device, said analyzing means in wireless communication with said sensor device, said analyzing means generating an indication of the presence, absence or quality of at least one of the parts, said analyzing means in wireless communication with said ejection means, wherein said ejection means is responsive to said indication.

15. The machine of claim 14, wherein said image capture means is at least one lens.

16. The machine of claim 14, wherein said ejecting means is at least one ram.

17. The machine of claim 14, wherein said means for controlling said ejecting means is a programmable microprocessor.

18. The machine of claim 14, wherein said analyzing means is a programmable microprocessor.

19. The machine of claim 14, further comprising an infrared emitting source, wherein said infrared emitting source illuminates at near-infrared frequencies.

20. A method of indicating the presence, absence and quality of a part in a part-forming machine, comprising the steps of:
a. acquiring an image of the part;
b. transferring said image to an image analyzer via wireless transfer means;
C. analyzing said image; and
d. sending a signal to a part-forming machine controller, via wireless transfer means, wherein said part-forming machine controller is responsive to said signal from said image analyzer.

21. The method of claim 20, wherein said wireless transfer means is a spread-spectrum radio frequency communication platform.

22. The method of claim 20, wherein said wireless transfer means is an infrared communication system.

23. A wireless image processing device for use with a machine vision system, comprising:
at least one sensor, wherein at least one target is imageable by said at least one sensor;
at least one wireless transmitter for transmitting the image captured by said at least one sensor;
at least one image analyzer for analyzing the image received from said at least one wireless transmitter for an indication of the status of said at least one target; and
at least one wireless transmitter for transmitting said indication of the status of said at least one target to a controller, wherein said controller wirelessly signals at least one operational direction in response to said indication and said at least one operational direction controls performance of the machine having said machine vision system incorporated therewith.

24. A wireless communication system for utilization with a machine having a vision system, comprising,
a sensory device, said sensory device acquiring visual data and wirelessly communicating said visual data to a controller;
a data analyzer, said data analyzer analyzing said visual data and wirelessly communicating a result to a controller; and
a controller, said controller wirelessly communicating a command signal to said sensory device and to the machine.

25. A sensory system for use with a machine, comprising,
at least one sensory device having wireless data communication capabilities; and
at least one host computer, wherein sensory information from said at least one sensory device is received and analyzed, and wherein at least one task of the machine is directed thereby.

26. The sensory system of claim 25, further comprising a wireless input/output controller for the machine.

27. A modular machine sensory system comprising,
a wireless image data acquisition and transfer system; and
a wireless input/output data transmission system.

28. An image processing system for use with a machine for forming parts, said image processing system comprising:
at least one sensor having an analyzing means carried thereby, wherein the parts formed by the machine are imageable by said at least one sensor, and wherein said means for analyzing determines an indication of the presence, absence or quality of at least one of the parts; and
means for wirelessly transmitting said indication to the machine, wherein the operation thereof is responsive to said indication.
